(19) United States
(12) Patent Application Publication
(10) Pub. No.: US 2024/0371233 A1
(43) Pub. Date: Nov. 7, 2024

(54) SYSTEM AND METHOD FOR TRACKING PATRON GAMING TICKET REDEMPTION

(71) Applicants: Everi Payments Inc., Austin, TX (US); Everi Technology Pty Ltd, North Ryde (AU)

(72) Inventors: Adam Fong, Las Vegas, NV (US); Andre Soussa, North Ryde (AU)

(21) Appl. No.: 18/643,745

(22) Filed: Apr. 23, 2024

Related U.S. Application Data
(60) Provisional application No. 63/463,667, filed on May 3, 2023.

(51) Int. Cl. G07F 17/32

(52) U.S. Cl. CPC G07F 17/3244

(57) ABSTRACT

Methods and systems are provided for tracking of patron redemption of monetary value gaming tickets. In a method of anonymous tracking, at least one image of a patron seeking to redeem a monetary value ticket at a redemption station is obtained and is stored in association with information regarding the monetary value that the patron presented for redemption. Transactions by the same patron may be linked via the image of the patron. In another configuration, a patron's ID is read and a patron account is created in association with an issued media. The patron uses the media to identify their account when redeeming a monetary value gaming ticket. Reported information may be analyzed, such as for suspicious activity and money laundering reporting.

### RELATED APPLICATION DATA

This application claims priority to U.S. Provisional Application Ser. No. 63/463,667, filed May 3, 2023, which prior application is incorporated herein by reference in its entirety.

### FIELD OF THE INVENTION

The present invention relates to casino gaming systems which utilize monetary value tickets.

### BACKGROUND OF THE INVENTION

Casinos (more broadly known as gaming establishments, which depending on relevant gaming rules and regulations can include pubs, clubs, social clubs, supermarkets, gas stations, truck stops, convenience stores, restaurants, and hotels) generally use monetary value tickets as a mechanism for transferring monetary value to and from gaming machines (also known in some countries as pokies), in lieu of coins, currency, bank cards and the like. For example, in order to avoid the need to stock a gaming machine with coins or currency to be paid out to a player in the event the player wins a jackpot or wishes to cash out of the machine, the gaming machine is configured to generate a monetary value ticket. The player can then utilize that monetary value ticket at another gaming machine to associate value with it for play, or might desire to redeem the ticket. If the player wishes to redeem the ticket, the player might present it to a cashier who validates the ticket and pays the player coins and/or currency, or the player might present the ticket to an automated redemption station to do the same.

One problem with these monetary value tickets is that they may be used as part of a money laundering process. For example, a player might associate a large amount of currency with a gaming machine, then cash-out of the gaming machine and obtain a monetary value ticket for the amount of the currency. The player may then cash out that ticket at an automated redemption station, effectively receiving “clean money” that appears to flow from legitimate gambling. Solutions to these and other problems are desired.

### SUMMARY OF THE INVENTION

Methods and systems are provided for tracking of patron redemption of monetary value gaming tickets.

In one embodiment of the invention, tracking of patron redemption of monetary value gaming tickets may be anonymous (e.g. tracked without knowing the identity of the patron) or partially anonymous. In one configuration, at least one image of a patron seeking to redeem a monetary value gaming ticket at a redemption station is obtained and image information is stored in association with information regarding the monetary value gaming ticket that the patron presents for redemption. Transactions by the same patron may be linked via image information of the patron. Reported information may be analyzed, such as for suspicious activity and money laundering reporting. The patron may be required to provide an ID in order to complete certain transactions, thereby removing the anonymity of the patron.

Other embodiments of the invention comprise methods and systems for tracking monetary value tickets, including the redemption thereof, by identified patrons. In one configuration, a patron's ID is read and information regarding the patron's ID is stored in association with a patron account. The patron is issued a media tied to the patron account. When the patron seeks to redeem a monetary value gaming ticket, the patron presents their media and at least one monetary value gaming ticket for reading. The media is used to identify the patron's account and associate information regarding the monetary value gaming ticket therewith. The patron account information may be used to validate the monetary value gaming ticket for redemption and for use in reporting to third party systems.

Further objects, features, and advantages of the present invention over the prior art will become apparent from the detailed description of the drawings which follows, when considered with the attached figures.

### DESCRIPTION OF THE DRAWINGS

FIG. 1 is a diagram of a system in accordance with an embodiment of the invention;

FIG. 2 is a diagram of a system in accordance with another embodiment of the invention; and

FIGS. 3A and 3B are flow diagrams of aspects of a method of an embodiment of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention include, but are not limited to, methods and systems for tracking patron (or player) redemption of monetary value gaming tickets. In some embodiments, such tracking is facilitated when the identity of the patron is not known (e.g. the patron is anonymous) and particularly when the redemption is automated. As one example of the invention, an image of a patron who is redeeming a monetary value ticket (such as a monetary value gaming ticket) at a redemption station is captured, such as via an image capture device and that image information is associated with monetary value ticket redemption information. As another example, redemption of the monetary value ticket at the redemption station may require the player to provide identification, such as an ID. Other embodiments of the invention comprise methods and systems for tracking of monetary value ticket redemption by identified patrons.

### Anonymous Tracking of Patron Monetary Value Ticket Redemption

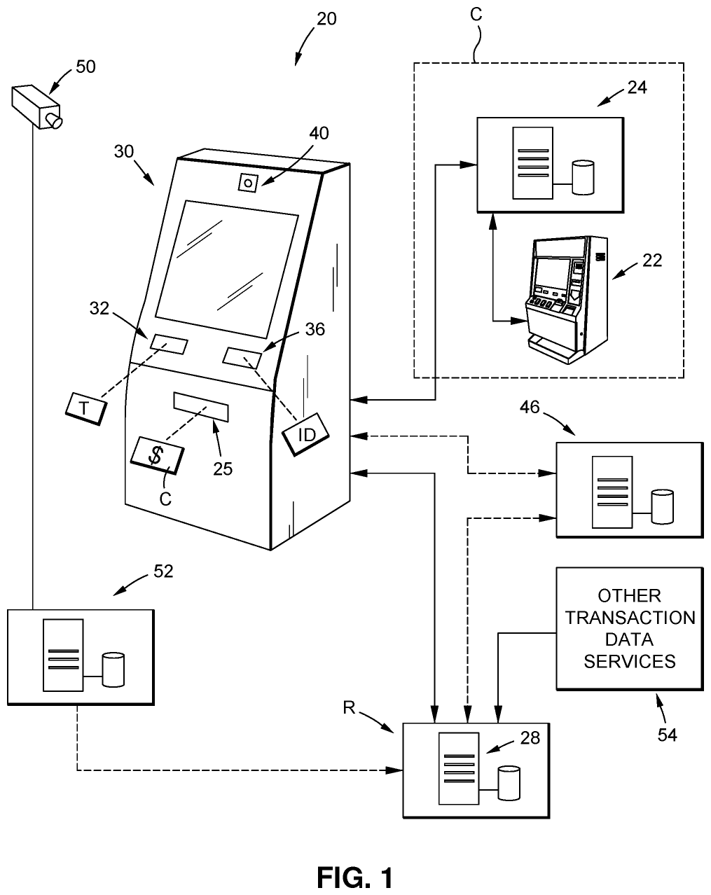

FIG. 1 illustrates one embodiment of the invention, which comprises a system 20. The system 20 may be referred to as a gaming system. As noted below, portions of the system might belong to or be operated by a casino (or the owner thereof) or entities other than a casino, and might be on-site or off-site as to the casino. In one embodiment, the system 20 may comprise elements associated with a casino, while other elements might be associated with and/or operated by one or more third parties, such as a casino vendor or financial processor.

As indicated, a casino C may include one or more devices and/or systems and may be associated with one or more physical locations. In one embodiment, the casino C may include one or more gaming devices 22. Such gaming devices 22 may have various forms and be configured to present a wide variety of games. For example, the gaming devices 22 might comprise “slot” type gaming machines (having mechanical or video-simulated reels), video poker gaming machines, or other types of gaming machines which are now known or later developed. In general, the gaming devices 22 are preferably configured to present one or more games (generally games of chance or games that include a skill component but which are still predominantly games of chance), such as in exchange for the placement of a wager.

In one embodiment, certain game outcomes (but preferably not all game outcomes) may be designated as winning outcomes (the non-winning outcomes may be referred to as losing outcomes). Prizes or awards may be provided for winning outcomes, such as monetary payments (or representations thereof, such as prize of credits). The awards might comprise, for example, awards of monetary value credits. Awards of a large size may be referred to as a “jackpot” award. In one embodiment, smaller awards might be awarded to the player as monetary value credits which are associated with a monetary value credit balance at the gaming machine. The player may be permitted to cash-out those credits, such as to a monetary-value ticket which the player can redeem at a cashier station or a redemption station (otherwise known as a kiosk or cash redemption terminal or CRT) for cash (e.g. coins or currency) or as monetary value associated with a gaming account, bank account or the like.

The gaming device 22 might be configured as a stand-alone device (such as where the one or more games are presented by execution of machine-readable code by a processor or controller of the gaming machine) or as a server-based device (e.g. where certain information or instructions is generated remotely, such as by a gaming server, and is transmitted to the gaming device) for presenting games as Class III games (as defined by the U.S. Indian Gaming Regulatory Act) or as a server-based device for presenting games as Class II games (as defined by the U.S. Indian Gaming Regulatory Act).

The gaming devices 22 might comprise other than gaming machines, and might comprise, for example, gaming tables or other gaming devices. For example, the gaming devices 22 might comprise gaming tables at which card games, dice games, roulette or other games are presented. A casino may have numerous such gaming devices 22, such as located on a casino floor or in other locations.

Referring still to FIG. 1, the casino C may include one or more systems and/or system elements, such as system servers. For example, the casino C might include at least one casino server 24. The casino server 24 may comprise a computing device which comprises at least one processor for receiving information, processing information or executing code or software, and generating an output, such as control instructions. The casino server 24 may also include means for storing information or instructions. Such means may comprise one or more memory devices. Such might comprise RAM, ROM (including EPROM, EEPROM, PROM) or other devices now known or later developed. In one embodiment, the servers may comprise or be in communication with one or more mass data storage devices, such as one or more hard drives or the like.

The casino server 24 preferably also includes at least one communication interface, by which it may receive and transmit information. The communication interface(s) may permit communications in accordance with various protocols (TCP/IP, 802.11xx, etc.) and in various forms and over various types of links (wired and/or wireless).

The casino server 24 might actually comprise a system or network of a plurality of elements or devices. For example, the server might comprise a network or system which includes multiple servers and related devices such as data storage devices, user interface features and the like. Such might comprise, for example, a user station which includes a video display and one or input devices (such as a keyboard, mouse or the like). Such a user station may permit an operator to interface with and manage or control the server, such as to change operator settings and the like. The casino server 24 might also comprise a router and one or more separate computing devices. The functions of the various computing devices might be segregated (including by executing different modules of software which implement different features/functions).

The one or more gaming devices 22 are preferably in communication with the at least one casino server 24 at one or more times. For example, the gaming devices 22 and the casino server 24 may be linked via one or more communication links. These communication links may be wired and/or wireless and may be dedicated, shared, part of a LAN, WAN or other network, such as an internal casino network.

The casino server 24 may be configured to implement accounting and ticketing functionality. In such a configuration, the gaming devices 22 may communicate with the casino server 24, such as when seeking to print a monetary value ticket upon a cash-out request of a player (such as to create a ticket record and associated amount), or when a player seeks to redeem a monetary value ticket at the gaming machine (such as to validate the ticket and its amount). The casino server 24 may, for example, generate and maintain records of monetary value tickets, including their amounts, whether they have been cashed-out, etc., and/or may perform other functionality, such as accounting functionality (tracking and reconciling monetary value provided to the gaming devices 22, amounts wager, amounts won, amounts cash-out, etc.).

The at least one casino server 24 may also implement other functionality. This might include player tracking functionality where the gaming devices 22 may communicate with the casino server 24 to report player activity and the casino server 24 maintains one or more player accounts, such as player loyalty accounts with game play information and loyalty awards. The functionality might include casino account functionality, such as for creating and tracking player monetary value accounts, such as accounts with associated monetary value that can be accessed by the player for wagering. The functionality might also include game functionality, such as where the gaming devices 22 may communicate with the casino server 24, such as to obtain game information, including game outcome information, to facilitate progressive jackpots or other gaming functionality, etc.

As illustrated in FIG. 1, the system 20 preferably includes a reporting system R. Elements of this system may be operated by an entity which is separate from the casino and one or more of the elements of the reporting system R might be located at the casino or be remote therefrom. In other embodiments, reporting system R might be part of the casino C, including being operated by the casino.

In one embodiment, the reporting system R comprises one or more reporting servers 28, such as similar to the casino servers (24), and thus having a communication interface, a processor and machine-readable code configured to be executed by the processor to implement various of the functionality described herein. The reporting system R may further include one or more data storage devices which are configured to store information.

The system 20 may further comprise one or more redemption stations 30 for use in redeeming monetary value tickets. The redemption station 30 may have a variety of configurations. In one embodiment, the redemption station 30 comprises a housing, one or more devices for receiving player input and/or displaying or otherwise providing information to a player. The information input/output devices may include, for example, an electronic touch-screen video display. Other input/output devices may include one or more push-buttons, keypads, keyboards and/or other elements.

The redemption station 30 preferably includes a means for accepting or reading at least one monetary value ticket T, such as a ticket reader 32, and at least one monetary value dispensing mechanism 34. Preferably, the monetary value dispensing mechanism comprises at least one mechanism for dispensing monetary value in a form other than a ticket, such as a currency dispenser 25 for dispensing currency C (illustrated in FIG. 1), a coin dispenser (not shown), or a value card such as magnetic strip or chipped stored value card or the like (not shown).

In one example, the redemption station 30 further comprises an ID reader 36. The ID reader 36 may comprise a wide variety of reading devices, such as one or more of a white light, IR and UV light scanner or reader, a magnetic stripe reader or the like. The reader 36 might be particularly configured to scan or read information associated with an ID, such as a state driver's license, passport or other government issued identification.

In one embodiment, the redemption station 30 includes at least one processor for executing machine readable code or software, and at least one memory device for storing machine readable code or software for execution by the processor. In one embodiment, the redemption station 30 includes at least one communication interface, such as for establishing a communication link with one or more other devices, such as the reporting server 28 and the casino server 24. While the redemption station 30 may be operated by an entity other than the casino, it is preferably located within the casino C, such as where a plurality of redemption stations 30 are located about the casino floor for access by players and/or attendants, as described below.

Preferably, the redemption station 30 includes at least one image capture device 40. The image capture device 40 may comprise, for example, a camera. The image capture device 40 is preferably located and oriented so that it is capable of capturing the image of a patron who is conducting a transaction at the redemption station 30, and preferably at least the face of that patron. Thus, as illustrated, the image capture device 40 might be associated with the housing or cabinet of the redemption station 30 and face the front thereof, so as to be pointed at a patron who is facing the front of the redemption station.

In other embodiments, the image capture device 40 might not be directly associated with the redemption station 30, such as by not being mounted to the redemption station 30. For example, a separate image capture device might be located near the redemption station 30 and still be arranged to similarly capture one or more images of a patron utilizing the redemption station 30.

Aside from the functionality described herein, the redemption station 30 might be configured to implement a wide variety of functionality or processes. For example, the redemption station 30 might facilitate ATM type services, check cashing, credit services, jackpot processing, etc. In this regard, while referred to as a redemption station 30 because one function thereof may be to facilitate the redemption of monetary value tickets, the redemption station 30 might be referred to as, or comprise, a kiosk or other types or configurations of interfaces.

As indicated above, the redemption station 30 includes one or more communication interfaces, such as for communicating over wired or wireless communication links with other devices and systems. For example, the redemption station 30 is preferably configured to communicate with the reporting system R to provide information to the reporting system R, as detailed below.

Further, the redemption station 30 preferably communicates with the casino server 24, such as to validate presented monetary value tickets. In this process, as is well known, read monetary value ticket information (read by the reader 32 from a presented ticket T), may be transmitted to the ticketing server 24 for validation. For example, this information may comprise a ticket number and amount which is used by the ticketing server 24 to determine if the ticket is valid and unredeemed. If not, the ticket redemption may be denied. If validated, the ticketing server 24 may transmit an approval to the redemption station 30 to issue monetary value to the patron in the amount of the value of the ticket.

In one embodiment, the reporting system R is configured to communicate with other systems and devices. The communications may occur via the Internet and/or other communication networks (wireless and/or wired, LANs, WANs, etc.).

As one example, either or both the reporting system R and the redemption station 30 may communicate with at least one authentication system 46. The authentication system 46 might comprise, for example, the FinScan® system operated by Innovative Systems, or the VeriDocs® system operated by VeriDocs, Inc. Such an external system may implement an ID authentication system which is known in the art.

As indicated, in one embodiment, one or more image capture devices 50 may be provided external to or apart from the redemption station 30. These image capture devices 50 may again comprise cameras, such as digital video cameras. They may be associated with a security system 52, such as of the casino C. This system 52 may include one or more computing devices, such as servers having a processor, a memory and at least one data storage device. The security system 52 may be configured to obtain and store image information from one the one more image capture devices 50, such as for storage in the data storage device. The processor of the security system 52 may be configured to analyze the image information, such as to identify patrons, suspicious activity and the like.

In one embodiment, the image capture device(s) 50 may be adapted to capture images of patrons having a wide range of heights and/or at a variety of distances, such as by means of one or more of: a wide angle lens suitable for capturing an expected range of patron heights; an ability to crop an image of a patron taken thereby; a zoom lens; or other means for recording and/or analyzing the face of the patron. The image capture device(s) 50 may include a lens with a movable mount capable of tracking the face of a patron. In one embodiment, the image capture device(s) 50 or associated system may include the ability to discard any facial images that are not considered to be the image of a patron, such as facial images of people behind or alongside a patron. Moreover, in one embodiment, the image capture device(s) 50, the redemption station 30, and/or the reporting system R (or other elements of the system) may be configured to convert images of a patron into various formats, such as representative information. Such might comprise, for example, conversion of an image of a patron to a vector image or other vector data. In this regard, as described herein, “image information” may mean a pixel image, a vector image or other data which represents an image of the patron. For example, in order to avoid storing an actual image of a patron, an image may be converted to a representative data file, such as a vector image, and that image information may be stored and used by the system or elements thereof.

As indicated, the reporting system R may communicate with the security system 52, such as to obtain image information or analyzed image information.

In one embodiment, as described below, the reporting system R may be configured to receive information regarding transactions occurring at the redemption station 30. The reporting system R may be configured to store that transaction information and analyze the transaction information. In this regard, as one aspect of the invention, the reporting system 30 may implement anti-money laundering (AML) functionality and/or suspicious activity reporting functionality, such as in which reports are generated and/or the reporting system R sends reports to the casino C and/or third parties (government agencies, etc.).

Thus, aside from obtaining information from the redemption station 30, the reporting system R may obtain information from other devices or systems 54. For example, the reporting system R might obtain information from a jackpot processing system, cashier stations or cages, other types of transaction terminals, the casino server 24, and from user devices or workstations (such as for manually inputting information to the reporting system R, such as of user-viewed transactions or suspicious activity).

Most importantly, in one embodiment, the system 20 is configured to implement anonymous patron monetary value ticket redemption tracking. First, in one embodiment, when a patron seeks to redeem a monetary value ticket T, one or more images of the patron are captured. The image information may be obtained by the image capture device 40 associated with the redemption station 30, or other image capture devices 50—such as associated with the security system 52. In some embodiments, image information may be captured continuously or regularly (such as at spaced intervals)-regardless of the initiation of a transaction occurring at the redemption station 30—such as may thus result in the capture of image information regarding the patron as they walk through the casino C, as they engage in other activities at the casino C, as they approach the redemption station 30, etc. In other embodiments, the image information may be captured in direct response to the patron engaging the redemption station 30, such as requesting redemption of a monetary value ticket T (e.g. in which case, the redemption station 30 may trigger the image capture device 40 to capture image information).

In one embodiment, captured image information is provided to the reporting system R, as is information regarding any monetary transaction occurring at the redemption station 30. This information might comprise, for example, a time of the transaction, the amount of the transaction, and even monetary value ticket T information (such as the ticket ID). In one embodiment, this information is preferably correlated, such as by which the image information of the patron who requested the transaction is linked to the information regarding the transaction.

In the event image information is captured apart from a particular transaction, that image information may be analyzed and linked to the transaction information. For example, in one embodiment, even though the identity of a patron may not be known (e.g. the player's name, contact information, etc., is not known), information regarding a patron may be linked and stored, such as for analysis and reporting. As one example, a first record may be generated which corresponds to a patron engaging in a monetary value transaction. Later images of that patron may be captured by the security system 52 and may be provided to the reporting system R, such as in relation to the patron's presentation of funds at a cashier cage or the like for conversion to chips. That later image information may be analyzed and compared to those stored by the reporting system R to determine that, based upon the image information, the patron is the same (or not) in both instances. This type of analysis may be used to link activities of a patron, even though the identity of the patron may be unknown or not yet identified. Of course, over time, a plurality of images and associated ticket records may be stored, whereby when information regarding a new transaction is received (along with an associated image), that image may be compared to the plurality of stored images of different patrons to see if the patron who is attempting the present transaction is the same as any of the earlier patrons. If not, a new record may be created.

It will also be appreciated that the manner by which the patron image and transaction information is stored or linked may vary. For example, in one embodiment, each time a new patron is identified (by an image which does not match any existing images), an identifier may be created (such a code, P1) and the image and the ticket information may be linked to that code. In other instances, the data (image and information regarding one or more tickets) might be directly linked.

Most importantly, the reporting system R may link monetary value ticket T redemption transactions, such as to determine that a particular patron is engaged in a large number of such redemption transactions and/or transactions of a very high value-which may indicate that the patron is engaged in money laundering activities.

As indicated above, in one or more embodiments, the reporting system R may analyze the reported information to determine suspicious activities, such as for generating one or more suspicious activity reports. The reporting system R may also analyze the reporting information to generate AML information, such as reports. As one example, such reports might be provided to the casino C to bar the patron from the casino C or prevent the patron from engaging in other transactions, to alert authorities to potential unauthorized activity of the patron, etc.

As another aspect of the invention, the redemption station 30 may be configured to capture patron ID information. For example, in some embodiments, the redemption station 30 may require the patron to provide an ID or identity information in order to engage in certain transactions, such as certain monetary value ticket T redemptions.

As one example, if the value of the monetary value ticket T is over a limit, or of the total value of monetary value tickets T during a certain period (day, week, etc.), exceeds a certain value, or the number of monetary value tickets T redeemed in a period of time exceeds a certain number (such as regardless of amount), etc., the patron may be required to provide such identity information before the redemption station 30 allow the patron to complete the transaction. As one example, the redemption station 30 may report patron image information to the reporting system R, along with information that the patron is requesting redemption of a monetary value ticket T having a value of $5000.00. The reporting system R may compare that captured image information to stored image information and associated transaction information and determine that the image corresponds to a patron who already redeemed monetary value tickets T having a total value of $10,000.00 that same day. The reporting system R may thus transmit a signal or instruction to the redemption station 30 to cause it to display or indicate to the patron that identity information is required before the presented monetary value T can be redeemed.

In one embodiment, the patron may then provide their ID to the reader 36 of the redemption station 30. As noted above, the ID might comprise a state driver's license, passport or the like. The ID might be read or scanned in various manners, such as to obtain a white light image of the front and back of the ID, a UV light image of the front and back of the ID, an IR light image of the front and back of the ID, and to read information associated with any magnetic stripe associated with the ID.

If the ID is successfully read, the ID information is preferably transmitted to a remote authentication vendor for authentication. This step may comprise the redemption station 30 or reporting system R transmitting the read ID information to the authentication system or server 46, such as of the remote vendor. The authentication vendor preferably reviews the ID information and attempt to valid that information, such as by comparison of information associated with the ID with information in one or more databases, such as databases of state ID information and the like. Of course, the particular authentication may be dependent upon the vendor.

The results of the authentication may be used, at least in part, to approve or deny the requested transaction, such as by the redemption station 30 or the reporting system R. Of course, other information might be used as part of determining whether to approve or deny the transaction. As one example, if the transaction amount is above a certain threshold, then it may be denied if the ID authentication results do not reach a designated degree of certainty, while that level of certainty might be lower for lower transaction amounts.

If the transaction is denied, the redemption station 30 to indicate such to the patron and/or to indicate to the patron that they need to complete the transaction via an in-person transaction, such as at a casino cage where other or additional information might be required (which information may be provided to the reporting system R). In one embodiment, when the transaction is denied, the reporting system R and/or the redemption station 30 may store and/or transmit information to the casino server 24 to quarantine that ticket to prevent it from being presented for redemption at the redemption station 30 or another device or station—by which the ticket may only be redeemed pursuant to the required process (such as in person at a casino cashier or cage).

If the transaction is approved, then the transaction may be completed. This might comprise, for example, the reporting system R transmitting an approval to the redemption station 30 which allows it to complete the transaction with the casino server 24. The redemption station 30 may then cause the monetary value dispensing mechanism 34 to dispense monetary value.

In a preferred embodiment, when patron identity information is obtained, it is associated with the patron's image information and transactions, whereby the previously ‘anonymous’ status of the patron (and the associated transactions) becomes non-anonymous. That information might then be shared with the casino C, other systems and the like, such as for tracking or vetting other activities of the patron.

The invention may have other features and configurations. As one example, the above-referenced steps may be performed in other orders or might include a greater or lesser number of steps.

Further, while in one embodiment of the invention, biometric data in the form of one or more images of a player are obtained and utilized, other or additional player biometric information might be obtained and utilized in a similar manner. In this regard, the system and/or redemption station might include other or additional biometric sensors. The sensors might comprise a biometric reader or identifier such as a fingerprint reader, retinal scanner, or other sensors for use in capturing patron information, and particularly information which is unique to a patron. Such information may, in a similar fashion to the image information, be linked to patron activity information and the like (e.g. instead of, or in addition to image information, a patron's retina might be scanned and the retina scan information might be associated with patron information, thus allowing information relating to the patron to be associated, even without knowledge of the identity of the patron).

As another example, the principles of the invention might be applied to a variety of transactions other than just ticket redemption. For example, aspects of the invention might be applied to a patron's purchase of a ticket (patron provides monetary value in the form of cash, a banking card, etc., and receives a monetary value ticket); purchase of a value card or account, or association of funds with such a card or account (such as a gaming card or account having associated value); withdrawing funds from such a value card or account; and/or obtaining cash (e.g. ATM type withdrawal), etc. As one example, a patron's engagement in these or similar transactions at a redemption station or similar device may trigger the capture of the patron's image and/or association of image information of the patron with such transaction information.

A particular advantage of the invention is that the system can collect, track and analyze information regarding activities of different patrons, even though the identity of those patrons may not be known.

In addition, the system may be configured to obtain patron identity information, thereby removing the anonymity of the patron.

### Tracking of Monetary Value Ticket Redemption by Identified Patrons

As indicated above, in some embodiments, the system may be configured to obtain patron identity information, thereby removing the anonymity of the patron. Another embodiment of the invention is a method and system for tracking monetary value tickets, including the redemption thereof, by identified patrons.

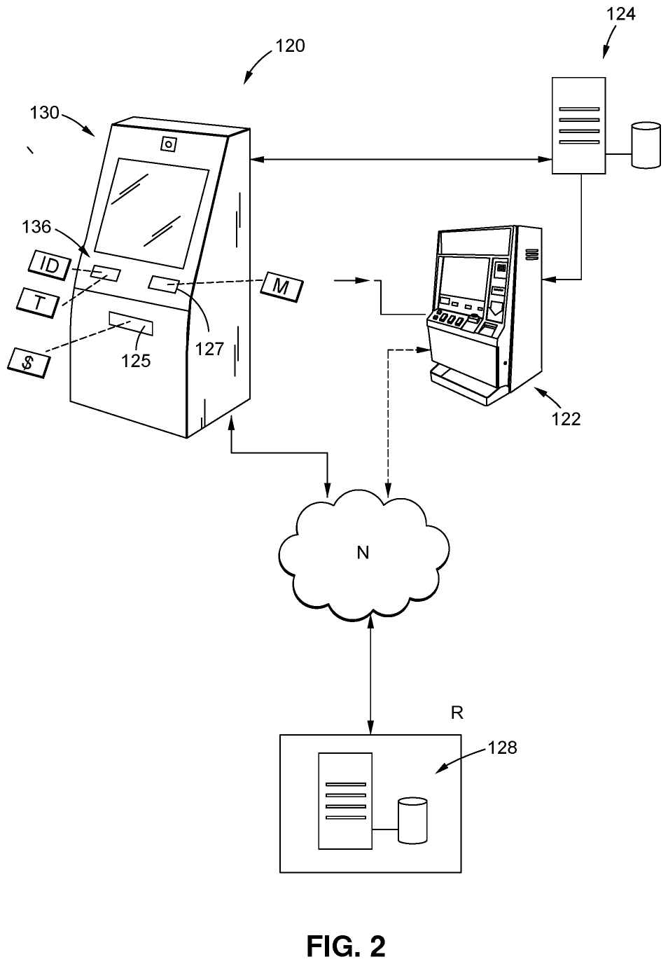

FIG. 2 illustrates one embodiment of such a system 120, wherein similar components to the system 20 described above have been given “100” series reference numbers. Once again, the system 120 may include one or more gaming devices 122, at least one casino server 124, at least one redemption station 130, and a redemption system R.

In accordance with the invention, the redemption station 130, or a separate kiosk or other device, is preferably configured to read, receive or acquire patron identity information, such as by receiving or reading information associated with an ID of a patron. As noted above, this might comprise a reader 136, such as a magnetic strip reader, optical reader/scanner, bar code reader, digital ID card reader, or other reader. The same or another reader may again be configured to read/receive a monetary value ticket T. Once again, the redemption station 130 is preferably configured to dispense monetary value, such as via a cash dispenser 125 or the like.

In this embodiment, the redemption station 130, or a separate kiosk, is configured to dispense a media M to a patron, such as from a media dispenser 127. In one embodiment, the media M is a card which has identifying information associated therewith. The media M might comprise, for example, a plastic or paper card with a magnetic stripe which is configured to store information, a plastic or paper card printed with machine-readable information (such as a QR code, bar code or the like), a plastic or paper card having an RFID tag associated therewith or the like. Of course, the media M might comprise other materials and have information associated therewith in other manners.

Once again, the redemption station 130 may communicate with a redemption system R, such as comprising one or more redemption servers 128, such as over a network N (which might comprise a LAN, WAN, the Internet, a dedicated network, etc.).

Additional aspects of the invention will be appreciated from a description of one embodiment of a method of the invention.

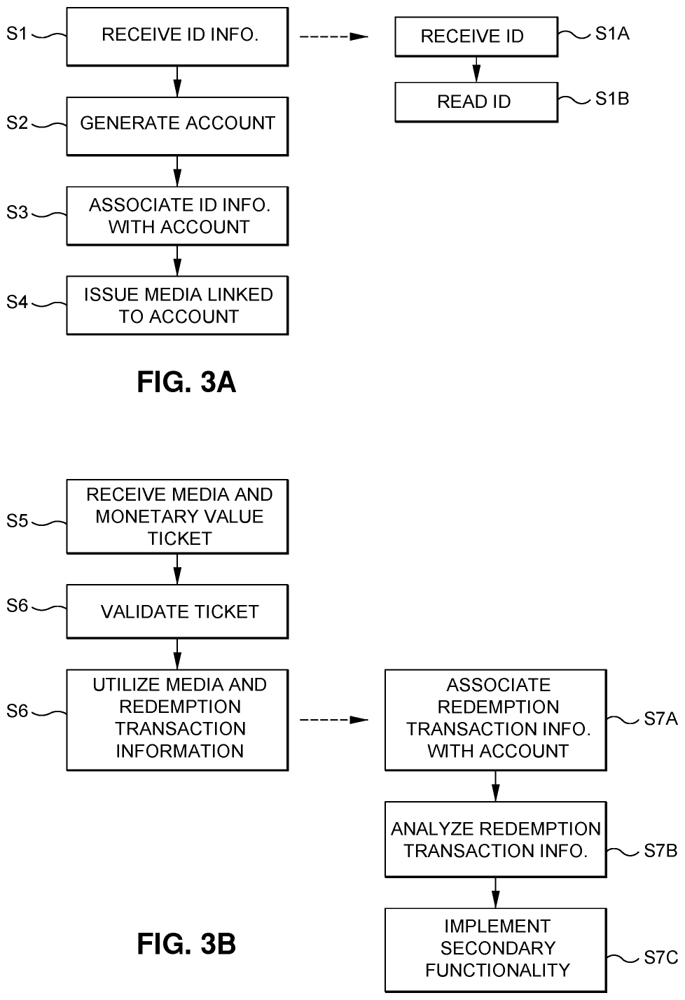

Referring to FIG. 3A, in a first step S1, patron identity information may be received. In one embodiment, this may comprise receiving an ID at a reader of the redemption station 130 (such as by association of the ID by the patron therewith), as a step S1A. In one embodiment, the ID may comprise a government issued ID, such as a driver's license, passport or the like, or other source of verifiable identity information. In a step 1B, information associated with the ID may be read, such as via the reader 136. As indicated above, such might comprise reading a machine-readable code associated with the ID, information associated with an RFID tag, a magnetic stripe or the like. The read ID information may be transmitted to the redemption system R and used to create a data record or account with which the read ID information is associated. For example, upon receiving the read ID information, the redemption server 128 may generate an account having a unique identifier and store the read ID information in association therewith in an associated database. Of course, step S1 might be implemented in other manners.

In a step S2, in response to the redemption station 130 transmitting information regarding the read ID information, the redemption server 128 may generate an account. In one embodiment, this information may comprise a unique identifier, such as an account or data record number. In one embodiment, the redemption server 128 may be configured to utilize the ID information to check to see if an account has already been opened (and remains valid) in relation to the ID information.

In a step S3, the patron ID information is preferably linked to the account. This may comprise, for example, associating the ID information with the account, such as the identifier therefor, in a database.

In a step S4, a media M is preferably issued to the patron, where that media M is linked to the account. This may comprise the redemption server 128 transmitting instructions to cause the redemption station 130 to issue the media M to the patron. This may cause the redemption server 130 to print information on a card which includes the account identifier (such as in the form of a machine-readable code), write the identifier to a magnetic stripe or RFID tag or the like, and then issue the media M to the patron, such as from the media dispenser 127 thereof.

In one embodiment, provisions may be made which allow a patron to obtain a duplicate media M (such as if lost), or alternatively to obtain a new media M, such as may be tied to the same account but which may have a different identifier, thus preventing use of the original media M, such as if it is lost or stolen.

In one embodiment, the account and the associated media M, may only be active or valid for a predetermined time, such as a calendar day, a period of hours or days, etc., whereby the media M is essentially a “temporary” media, such as might be used by a patron during a particular session of gaming and during which associated redemption transactions are linked, in the manner described below. In such a configuration, numerous accounts might be created for a single patron, such as corresponding to different gaming sessions. In some embodiments, those accounts may be linked, or might be configured as sub-accounts of a single account, whereby redemption transaction associated with a single patron might be tracked in periods as well as over a time span comprising multiple periods.

In one embodiment of the invention, the patron may play one or more wagering games or engage in other activities at one or more of the gaming devices 122. Such activities may result in the patron having a credit balance at the gaming device 122 (such as comprising monetary value associated with the gaming device 122 to wager on one or more wagering games or other activities, winnings paid, etc.). The patron may cash-out that credit balance, at which time the gaming device 122 may issue a monetary value ticket T which represents the amount of credit associated with the gaming device 122. In particular, as is described in U.S. Pat. No. 6,048,269 to Burns, which is incorporated herein in its entirety by reference, upon such a cash-out request, the gaming device 122 may request the generation of the monetary value ticket T. This request may be, for example, transmitted to an accounting system of the casino server 124. The casino server 124 may generate a ticket number and store the amount of credit in association therewith, and then cause the gaming device 122 to issue the monetary value ticket T with a unique ticket identifier.

Referring to FIG. 3B, a patron may at one or more times seek to redeem that monetary value ticket T by presenting it to the redemption station 130, as at step S5. This step may comprise, for example, the patron associating the monetary value ticket T with the reader 136 of the redemption station 130 (such as by inserting it into the reader, passing it under the reader, etc.).

In one embodiment, when the monetary value ticket T is read by the redemption station 130, it may be validated at step S6, such as by sending the ticket number (or other ticket identifying information) to the casino server 124. Assuming that the ticket T is valid (exists in the system, has not already been redeemed, etc.), then the casino server 124 may transmit a validation approval back to the redemption server 130.

Moreover, as one aspect of the present invention, in order to redeem a monetary value ticket T, the patron is preferably required to present their media M to the redemption station 130 for reading thereby, as indicated at step S5. The redemption station 130 may transmit the identifier associated with the media M to the redemption system R, which may be used by the redemption server 128 to locate the associated account. The redemption server 128 may determine if the media M is valid, such as if it is expired. As indicated above, a media M issue to a patron may only be valid for a period of time. If the patron attempts to utilize the media M after it is expired, the patron may be notified (such as by instructions displayed on a display of the redemption station 130) that they need to obtain a new media (such as via the process described above).

In one embodiment, as indicated at step S7, the redemption system R is configured to track (e.g. record/store information regarding patron redemption transactions) and may be configured to utilize that tracked information to implement associated or secondary functionality, such as one or more of: 1) blocking redemption transactions; 2) triggering or generating required tax or reporting forms; 3) detecting money laundering and/or reporting suspicious activities, among other functions.

For example, in a preferred configuration, the redemption station 130 transmits information regarding the requested redemption transaction, such as the identifier of the monetary value ticket T and/or the amount being redeemed, as well as the identifier of the media M. The redemption server 128 may first associate information regarding the requested redemption transaction with the patron account (as at step S7A), may then analyze the redemption transaction information associated with the account (as at step S7B), and may then implement one or more secondary functions, such as at step S7C.

For example, based upon the analysis of the redemption transaction information, the redemption system R may cause the redemption station 130 to deny the redemption. In such a configuration, the patron may be required to complete the transaction in another manner, such as in-person at a cashier. In such event, the patron may travel to a cashier and present the ticket for redemption T. The cashier may, as part of processing that transaction, require the patron to provide their ID for validating the identity of the patron, might validate the patron's ID (such as by scanning it and sending it to an outside ID verification company for authentication), or might engage in other steps, before deciding whether to redeem the ticket T.

If the redemption transaction is permitted, the redemption system R (such as the redemption server 128) may instruct the redemption server 130 to dispense the monetary value (such as cash) to the player.

In a preferred embodiment, all information regarding attempted monetary value ticket redemption transactions which are associated with the media M (e.g. whether at the redemption station 130, via cashier, etc.) are linked to that media M, such as the associated account stored at the redemption server 128. For example, the account at the redemption server 128 might include data record which indicate the amount of each attempted redemption, the status (rejected/completed, etc.), the time and the location.

As indicated, based upon the analysis of the transaction information associated with the account, various secondary functionality might be implemented. For example, an analysis of that information might trigger the generation of a suspicious activity flag or report (such as by the redemption server 128 or by transmission of information from the redemption server 128 to another system, such as a casino anti-money laundering system). As another example, a particular transaction or transactions might be analyzed and trigger the generation of tax reporting forms.

An important aspect of the invention is that monetary value ticket T redemption transactions are associated with particular patrons (as identified by their ID information). This allows, for example, the reporting of such information to governmental authorities, such as for anti-money laundering tracking and enforcement activities.

In some embodiments, ID information from the patron might be transformed, such as by running it through a hash, turning it into a machine-readable code or the like, such as to prevent direct storage of patron ID information.

In some embodiments of the invention, the patron may be required to utilize their media M in order to engage in activities at the one or more gaming devices 122, or at least as a requirement to allowing the patron to cash-out to a monetary value ticket T, the patron may be required to provide their media M to the gaming device 122. In this configuration, the gaming device 122 may include a media reader for reading the media M and may be in communication with the redemption system R so as to report transactions or other information associated with the media M, which information may be associated with the account.

The invention has particular applicability to smaller gaming venues, such as pubs. In such a venue, the described functionality may be implemented by providing one or more redemption stations. The redemption station(s) may be communicatively coupled to the redemption system R, which in a preferred embodiment may be located remotely from the pub or other gaming location. The redemption system R may serve as a remote central system for a plurality of different pubs or other gaming locations, thus eliminating the need for each location to have its own redemption system R, such as associated redemption server 128.

However, features of the invention may be implemented a larger casinos, including those which run a central casino management system or the like. In these environments, the casino may already implement a player tracking system in which player accounts are generated and players use account information (such as an issued player card) to identify themselves relative to various activities (play of gaming machines, etc.). In such a configuration, these existing account and any associated player ID information may be utilized in a similar manner to that described herein. In particular, a player may be required to utilize their player tracking system ID when they wish to redeem a monetary value ticket T, such as at a redemption station, thus allowing the association of such redemption information to be tracked relative to a particular patron.

It will be appreciated that functions of the redemption station described herein might be performed by different devices. For example, instead of a single redemption station which both reads information from a patron ID and issues media M and accepts monetary value tickets for redemption, one device, such as a kiosk or the like, might be configured to read information from a patron ID and issue media M, and another device might be configured to accept monetary value tickets for redemption (and issue monetary value therefor).

While the invention has been described generally with reference to a casino or similar property having redemption terminals described herein, it will be appreciated that the system might comprise more than one casino or similar property, wherein information from the devices at those locations (redemption terminals/cameras, etc.) might be linked, such as to track activities of patrons (such as centrally) relative to and across those different locations, thus providing an enhanced view of the activities of the patrons.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A system for tracking of patron redemption of monetary value gaming tickets comprising:
at least one monetary value gaming ticket redemption station comprising a housing, a processor, a memory, machine readable code stored in said memory and executable by said processor, at least one video display, at least one patron input device, a reader, a media dispenser, and a money dispenser; and
a reporting system comprising a computing device comprising a processor configured to execute machine readable code, a memory, a communication interface, and machine readable code stored in the memory the executable by the processor and a data storage device;
wherein the machine readable code of said reporting system is configured to, in response to receiving information regarding a patron ID read by said reader of said monetary value gaming ticket redemption station, create a patron account and cause said monetary value gaming ticket redemption station to issue a media to said patron via said media dispenser;
wherein said the machine readable code of the monetary value gaming ticket redemption station is configured to, in response to said reader thereof reading said patron media and a monetary value gaming ticket presented to said reader, transmit information regarding said patron media and said monetary value gaming ticket to said reporting system and, when validated, cause said money dispenser to dispense money for the redemption of said monetary value gaming ticket.

2. The system in accordance with claim 1, wherein said patron media comprises a temporary printed card.

3. The system in accordance with claim 2, wherein said printed card bears patron account identifying information.

4. The system in accordance with claim 1, wherein the machine readable code of the reporting system is configured to utilize the information regarding the patron media transmitted from the monetary value gaming ticket redemption station to identify said patron account and to associate said information regarding said monetary value gaming ticket therewith.

5. The system in accordance with claim 4, wherein said machine readable code of the reporting system is further configured to analyze information stored in association with said patron account as part of a determination of whether to validate said monetary value gaming ticket.

6. The system in accordance with claim 5, wherein when said monetary value gaming ticket is not validated, said monetary value gaming ticket redemption station displaying instructions on said at least one video display instructing said patron to redeem said monetary value gaming ticket at an attended redemption location.

7. The system in accordance with claim 6, wherein said attended redemption location comprises a cashier.

8. The system in accordance with claim 1, wherein said patron media has an expiration date.

9. A method of tracking patron redemption of monetary value gaming tickets, comprising the steps of:
reading; via at least one reader device; information associated with a patron ID;
creating, in a database, a patron account in association with said patron ID information;
issuing, via a media dispenser, a temporary use media to said patron;
reading, via said at least one reader device, said temporary use media and a monetary value gaming ticket presented by said patron;
utilizing information read from said temporary use media to identify said patron account in said database;
associating information regarding said monetary value gaming ticket; and
utilizing information associated with said patron account to validate redemption of said monetary value gaming ticket for money.

10. The method in accordance with claim 9, further comprising determining if said temporary use media is expired.

11. The method in accordance with claim 9, wherein said patron ID is read by at least one reader device comprising an ID reader.

12. The method in accordance with claim 11, wherein said ID reader comprises an ID scanner.

13. The method in accordance with claim 9, wherein said monetary value gaming ticket is read by at least one reader device comprising a ticket reader.

14. The method in accordance with claim 9, further comprising the step of authenticating, via a monetary value gaming ticket system, said monetary value gaming ticket.

15. The method in accordance with claim 14, wherein said step of authenticating comprises confirming a monetary value of said monetary value gaming ticket.

16. The method in accordance with claim 9, wherein said temporary use media can only be utilized one day.

17. The method in accordance with claim 9, further comprising transmitting patron monetary value gaming ticket redemption information from said patron account to a third party system for reporting.
